(19) United States
(12) Patent Application Publication
(10) Pub. No.: US 2006/0182427 A1
(43) Pub. Date: Aug. 17, 2006

(54) [MULTIMEDIA PLAYER]

(75) Inventors: Horace Chen, TAIPEI (TW); Jiunn-Yeong Yang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 10/906,329

(22) Filed: Feb. 15, 2005

(51) Int. Cl. H04N 5/781

(52) U.S. Cl. 386/125

(57) ABSTRACT

The present invention discloses a multimedia player, which has a controller chip separately connected to an audio/video transmission interface, a hard disk, a USB connecting interface and a control interface, and the controller chip installs a digital signal processing (DSP) chip and a USB controller. Since a hard disk is used as a storage device for the multimedia player, the multimedia player can have more data storage spaces to lower the cost of video recording or audio recording, and thus further lowering the price of the product and stimulating consumer's desire for the purchase. The USB connecting interface is connected to an electronic product having a host, so that the multimedia player can directly play the data stored in the electronic product having a host or store data into the hard disk of the multimedia player.

### BACKGROUND OF THE INVENTION

1. Field of the Invention

The present invention relates to a multimedia player, and more particularly to a multimedia player capable of being connected to an electronic product having a host and using a hard disk as its storage device.

2. Description of the Related Art

Thanks to the advancement of science and technology, our living model is changing constantly. Science people pay more attentions on leisure activities in these days, the concept of “Home Entertainment Center” is widely accepted with the promotion of the “Five Working Days per Week” policy. Television and video recoding and playing formed a hot wave at early days, and they are being gradually replaced by VCD and DVD disk drives due to the rapid advancement of science and technology. At present, the optical disks available for optical disk drive include a write-once VCD disk, a multiple erasable and writeable VCD disk, a write-once DVD disk, and an erasable DVD disk. In these optical disks, the digital audio/video data is copied onto the optical disk, and the digital audio/video data is decoded by the optical disk drive, such that the decoded data can be played by a screen display or a loudspeaker connected to the optical disk drive and users can enjoy various kinds of entertainments. However, users are facing a major problem regardless of the optical disk they use for storing the audio/video data, and such problem refer to the storage capacity. In general, a VCD disk can store approximately 720 MB of data, and a DVD disk can store approximately 4 GB of data, and thus the limited storage capacity of the optical disk causes much inconvenience to users. For example, when the quantity of audio/video data is very large, users have to store the huge data separately into several different optical disks before such data can be used and played by the optical disk drive. Therefore, users have to change the optical disk in the optical disk drive frequently. If a user has to focus on playing a movie or a song from a multimedia player, it is very inconvenient for the user to keep changing the optical disks, which will turn off the user's desire for viewing the movie or listening to the music.

At present, most users have the habit of downloading a movie or a song from the Internet, and the downloaded movie or song is played by a computer. Users are usually not satisfied with the resolution of display or the fine tune of sound, and people often want to play the movie or the music by professional audio/video equipment. In that case, the user has to copy the desired movie or music onto an optical disk first, and then connects the optical disk drive to the audio/video equipment for playing. Such arrangement requires a complicated procedure that makes the application unfriendly; and furthermore, errors often occur during the disk duplication process. Any failure of a duplication of the optical disk incurs a higher cost.

Further, most of the general optical disk drives having the playback function come with an acceptable reasonable price, but the optical disk drives having the recording and duplication function have a high price. In general, a consumer usually takes the price into consideration and purchases an optical disk drive having the playback function only, because the equipment having the duplication function is very expensive, and consumers cannot enjoy the video recording and audio recording functions. Therefore, the subject of overcoming the foregoing problems and shortcomings demands immediate attentions, and the improvements by manufacturers in the related field are needed.

### SUMMARY OF THE INVENTION

The present invention has been accomplished under the circumstances in view. Therefore, it is a primary objective of the present invention to use a universal serial bus (USB) connecting interface built in a multimedia player to connect an electric product having a host, so that the multimedia player can directly play the data stored in the electronic product having a host from the audio/video device connected to the multimedia player or save the data into a hard dist built in the multimedia player, and thus giving a powerful extended function to the multimedia player. Since a hard disk is used as the storage device of a multimedia player, therefore more memory spaces are available for storing huge audio/video data and users can use the multimedia player in a more convenient way.

The secondary objective of the present invention is to use a control circuit built in the multimedia player to directly store the audio/video data into the hard disk of the multimedia player for playing the audio/video device, so as to lower the cost for video recording or sound recording, and further lower the selling price of the product as well as stimulating consumer's desire for the purchase.

### BRIEF DESCRIPTION OF THE DRAWING

FIG. 1 is a block diagram in accordance with the present invention.

### DETAILED DESCRIPTION OF THE EMBODIMENT

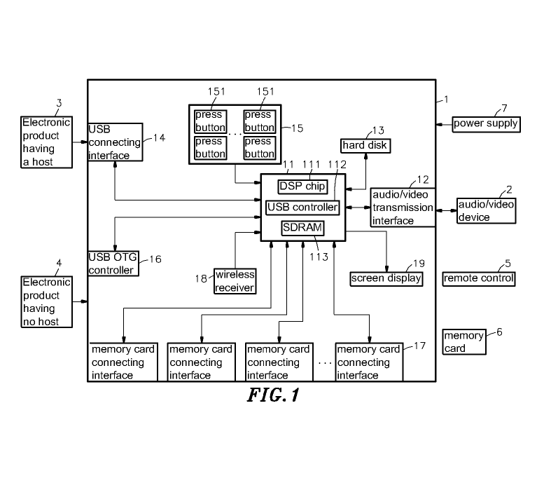

Referring to FIG. 1, a multimedia player 1 of the present invention comprises a controller chip 11, an audio/video transmission interface 12, a hard disk 13, a universal serial bus (USB) connecting interface 14, a control interface 15, a universal serial bus OTG controller 16, a memory card connecting interface 17, a wireless receiver 18 and a screen display 19.

The controller chip 11 installs a digital signal processing (DSP) chip 111, a universal serial bus (USB) controller 112, and a synchronous dynamic random access memory (SDRAM) 113, and the SDRAM 113 can temporarily save the control instruction given by the control interface 15 or can temporarily save the control instruction given by the wireless receiver 18.

The audio/video transmission interface 12 is connected to the controller chip 11 and the audio/video transmission interface 12 is provided for connecting an audio/video device 2.

The hard disk 13 is connected to the controller chip 11, and the hard disk 13 can store data.

The USB connecting interface 14 is connected to the controller chip 11, and the USB connecting interface 14 is provided for connecting an electronic product 3 having a host.

The control interface 15 is connected to the controller chip 11, and the control interface 15 installs one or more press buttons 151.

The universal serial bus OTG controller 16 is connected to the controller chip 11, and the universal serial bus OTG controller 16 can be connected to an electronic product 4 having no host, and such universal serial bus OTG controller 16 has a major feature of providing a way of connecting two devices without going through a computer or any other host as to achieve a point-to-point connection.

The memory card connecting interface 17 is connected to the controller chip 17, and the quantity of memory card connecting interface 17 could be one or more, and the memory card connecting interface 17 could be a MS memory card connecting interface, a MMC memory card connecting interface or a CF memory card connecting interface.

The wireless receiver 18 is connected to the controller chip 11, and the wireless receiver 18 can receive a control signal transmitted from a remote control 5.

The screen display 19 is connected to the controller chip 11, and the screen display 19 can display the operating status of a multimedia player 1.

If the audio/video transmission interface 12 installed in the multimedia player 1 is connected to the audio/video device 2 and the user uses a press button 151 of the control interface 15 to give instruction for playing, the DSP chip 111 installed in the controller chip 11 will decode the audio/video data stored in the hard disk 13, and the controller chip 11 will send the decoded audio/video data to the audio/video device 2 through the audio/video transmission interface 12 for playing. Since the present technology of a hard disk 13 allows a memory storage capacity up to 200 GB or more, therefore a user can store huge data at a time and needs not interrupt a long-time use of a multimedia player 1.

Further, when the USB connecting interface 14 is connected to an electronic product 3 having a host, the audio/video data stored in the electronic product 3 having a host can be sent to the controller chip 11 through the USB connecting interface 14 for the decoding. The decoded audio/video data is sent to the audio/video device 2 through the audio/video transmission interface 12 for playing, so that the multimedia player 1 can play the audio/video data stored in the electronic product 3 having a host through the USB connecting interface 14, and users can use the multimedia player 1 in a more convenient way. The electronic product 3 having a host could be a computer or a personal digital assistant (PDA).

When the memory card connecting interface 17 is connected to a memory card 6, the audio/video data stored in the memory card 6 can be decoded by the DSP chip 111 installed in the controller chip 11, and the decoded audio/video data can be sent to the audio/video device 2 through the audio/video transmission interface 12 for playing. The audio/video device 2 could be a display or a stereo.

If the foregoing electronic product 3 having a host and the memory card 6 are connected to the multimedia player 1 through the USB connecting interface 14 and the memory card connecting interface 17, the USB controller 112 installed in the controller chip 11 allows the electronic product 3 having a host, memory card 6, and hard disk 13 to transmit data with each other and improves the user's convenience.

With reference to FIG. 1 again, if a user wants to save the audio/video signals for playing by the audio/video device 2, the DSP chip 111 built in the controller chip 11 will continuously receive the audio/video data transmitted from the audio/video device 2, and the DSP chip 111 will code the audio/video signal into an audio/video data, and then will send the coded audio/video data to the hard disk 13 for its storage. Since the hard disk 13 has a function of writing data and its cost is much lower than the duplicating device of an optical disk drive, therefore users need not spend much money to enjoy the audio and video recording functions.

If the universal serial bus OTG controller 16 is connected to an electronic product 4 having no host (such as a flash memory or a card reader), the electronic product 4 having no host can transmit data with the hard disk 13 or the memory card 6.

Further, the wireless receiver 18 can receive a control signal transmitted from the remote control 5, so that a user can use the remote control 5 to control the operation of the multimedia player 1 from a remote end, and a power supply 7 can supply the required power for the operation of the multimedia player 1.

Further, the hard disk 13 could be a detachable or a non-detachable hard disk 13, and the hard disk 13 can be detached directly from the multimedia player 1 and used for the electronic product 3 having a host, so that the hard disk 13 can store/read data into/from the electronic product 3 having a host and then the hard disk 13 can be installed into the multimedia player for its use.

A prototype of multimedia player has been constructed with the features of FIG. 1. The multimedia player functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A multimedia player, comprising:
a controller chip, having a digital signal processing (DSP) chip and a universal serial bus (USB) controller;
an audio/video transmission interface, coupled to said controller chip for connecting an audio/video device;
a hard disk, coupled to said controller chip for storing a data transmitted from said controller chip or transmitting a data stored in said hard disk to said controller chip; a USB connecting interface, coupled to said controller chip for connecting an electronic product having a host; and
a control interface, coupled to said controller chip for letting a user operate said multimedia player.

2. The multimedia player as claimed in claim 1, wherein said control interface installed at least one press button.

3. The multimedia player as claimed in claim 1, wherein said controller chip further comprises a synchronous dynamic random access memory (SDRAM) disposed therein.

4. The multimedia player as claimed in claim 1, wherein said electronic product having a host is computer or a personal digital assistant (PDA).

5. The multimedia player as claimed in claim 1, wherein said hard disk is a detachable hard disk.

6. The multimedia player as claimed in claim 1, wherein said hard disk is a non-detachable hard disk.

7. The multimedia player as claimed in claim 1, wherein said controller chip is connected to universal serial bus OTG controller coupled to an electronic product having no host.

8. The multimedia player as claimed in claim 7, wherein said electronic product having no host is a flash memory stick or a card reader.

9. The multimedia player as claimed in claim 1, wherein said controller chip is coupled to at least one memory card connecting interface.

10. The multimedia player as claimed in claim 9, wherein said memory card connecting interface is a MS memory card connecting interface, a MMC memory card connecting interface or a CF memory card connecting interface.

11. The multimedia player as claimed in claim 1, wherein said multimedia player further comprises a power supply.

12. The multimedia player as claimed in claim 1, wherein said controller chip is coupled to a wireless receiver for receiving a control signal transmitted from a remote control.

13. The multimedia player as claimed in claim 1, wherein said controller chip is coupled to a screen display.

14. The multimedia player as claimed in claim 1, wherein said audio/video device is a display or a stereo.
